(19) United States
(12) Patent Application Publication
(10) Pub. No.: US 2023/0173893 A1
(43) Pub. Date: Jun. 8, 2023

(54) VEHICLE WINDOW GLASS

(71) Applicant: AGC Inc., Tokyo (JP)

(72) Inventor: Masayuki SASE, Tokyo (JP)

(73) Assignee: AGC Inc., Tokyo (JP)

(21) Appl. No.: 18/105,147

(22) Filed: Feb. 2, 2023

Related U.S. Application Data
(63) Continuation of application No. PCT/JP21/28825, filed on Aug. 3, 2021.

(30) Foreign Application Priority Data
Aug. 19, 2020 (JP) 2020-138550

(51) Int. Cl. B60J 1/00; H05B 3/86; H05B 3/56

(52) U.S. Cl. CPC B60J 1/002; H05B 3/86; H05B 3/56

(57) ABSTRACT

To provide a vehicle window glass with high quality, provide with a functional member.

Between an outer glass 28 and an inner glass 30, heating wires 27 provided with bus bars 20 and 22 are present, in a notch 14B, relay boards 16 and 18 are disposed, and on the relay boards 16 and 18, the bus bars 20 and 22 and the lead wires 24 and 26 are electrically connected respectively.

### CROSS-REFERENCE TO RELATED APPLICATIONS

This application is a Bypass Continuation of PCT Application No. PCT/JP2021/028825, filed on Aug. 3, 2021, which is based upon and claims the benefit of priority from Japanese Patent Application No. 2020-138550 filed on Aug. 19, 2020. The contents of those applications are incorporated herein by reference in their entireties.

### TECHNICAL FIELD

The present invention relates to a vehicle window glass.

### BACKGROUND ART

Some of vehicle window glasses are provided with a functional member having a heating function to remove ice and fogging (water droplets) attached to the glass, a light control function to optionally control a transparent state and a colored state, a display function to display drive information, etc. Such functional members are respectively provided with a power feeding portion and operate by being power-fed from a power source via the power feeing portion.

As the heating function, a wiper deicing function to defrost the wiper blade stop position, and an entire surface heating function to defrost the see-through region have been known.

Patent Document 1 discloses a window glass as a vehicle window glass having the above entire surface heating function mounted.

The window glass disclosed in Patent Document 1 has a glass plate having a heating wire print formed as a connecting portion, a conductor provided on the glass plate and electrically conducted to the heating wire print, and a lead wire electrically connected to the heating wire print and electrically connected to the conductor via the heating wire print. And, the heating wire print and the lead wire are electrically connected by solder.

### PRIOR ART DOCUMENTS

### Patent Documents

Patent Document 1: JP-A-2013-112122

### DISCLOSURE OF INVENTION

### Technical Problem

The heating wire print as disclosed in Patent Document 1 is a foil-shaped one formed, for example, by applying a silver paste to a glass plate by screen printing, and is very thin (for example has a thickness of from 5 to 20 μm). If a lead wire is to be connected to such a heating wire print by soldering (for example by lead free solder (melting point: about 230° C.)), heat at the time of soldering (for example, temperature of soldering iron: about 300° C.) may be transferred locally to the glass plate via the heating wire print, thus leading to cracks on the glass plate.

That is, in the case of a vehicle window glass provided with a conventional functional member, quality of the glass plate may sometimes be lowered by local heating of glass by soldering.

Under these circumstances, it is an object of the present invention to provide a vehicle window glass with high quality, having influence by soldering over glass suppressed even when provided with a functional member which requires power feeding.

### Solution To Problem

To achieve the above object, according to an embodiment of the present invention, provided is a vehicle window glass provided with a laminated glass comprising a vehicle exterior side glass and a vehicle interior side glass, and an interlayer sandwiched between the vehicle exterior side glass and the vehicle interior side glass,

wherein the vehicle interior side glass has a notch formed to penetrate in the plate thickness direction of the vehicle interior side glass at the edge portion on the lower side,

between the vehicle exterior side glass and the vehicle interior side glass, a functional member provided with a power feeding member is present,

a plate-like body is disposed in the notch, and

on the plate-like body, the power feeding member and a lead wire provided from outside the laminated glass are electrically connected.

### Advantageous Effects of Invention

According to the present invention, it is possible to provide a vehicle window glass with high quality, having influence by soldering over glass suppressed even when provided with a functional member which requires power feeding.

### BRIEF DESCRIPTION OF DRAWINGS

FIG. 1 is a perspective view illustrating an enlarged power feeding portion of a vehicle window glass according to a first embodiment of the present invention.

FIG. 2 is a cross sectional view illustrating the power feeding portion shown in FIG. 1.

FIG. 3 is a cross sectional view illustrating a power feeding portion having a sealing member disposed.

FIG. 4 is a plan view illustrating the power feeding portion shown in FIG. 3.

FIG. 5 is a cross sectional view illustrating an enlarged substantial part of the structure of a power feeding portion of a vehicle window glass according to a second embodiment of the present invention.

FIG. 6 is a plan view illustrating the power feeding portion shown in FIG. 5.

FIG. 7 is a cross sectional view illustrating an enlarged substantial part of the structure of a power feeding portion of a vehicle window glass according to a third embodiment of the present invention.

FIG. 8 is a plan view illustrating the power feeding portion shown in FIG. 7.

FIG. 9 is a cross sectional view illustrating an enlarged substantial part of the structure of a power feeding portion of a vehicle window glass according to a fourth embodiment of the present invention.

FIG. 10 is a plan view illustrating the power feeding portion shown in FIG. 9.

### DESCRIPTION OF EMBODIMENTS

Now, some of embodiments of the vehicle window glass according to the present invention will be described with reference to the drawings.

### First Embodiment

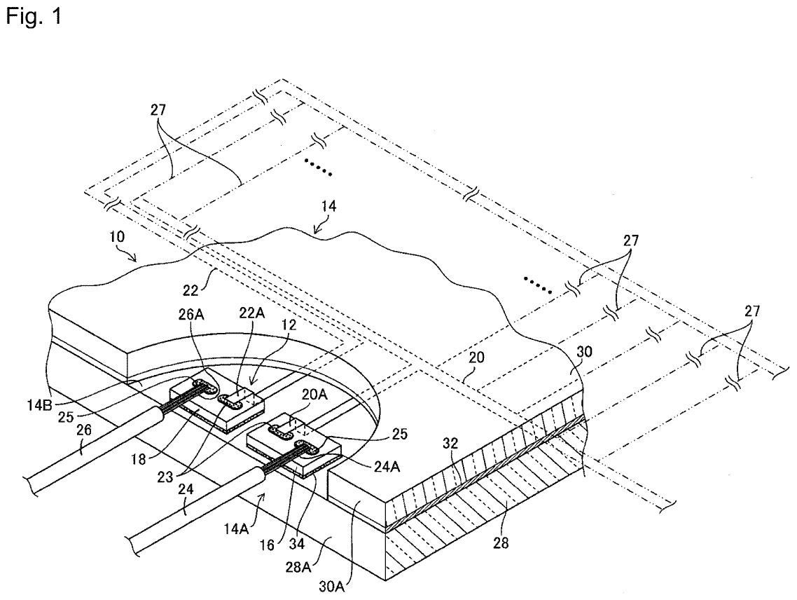

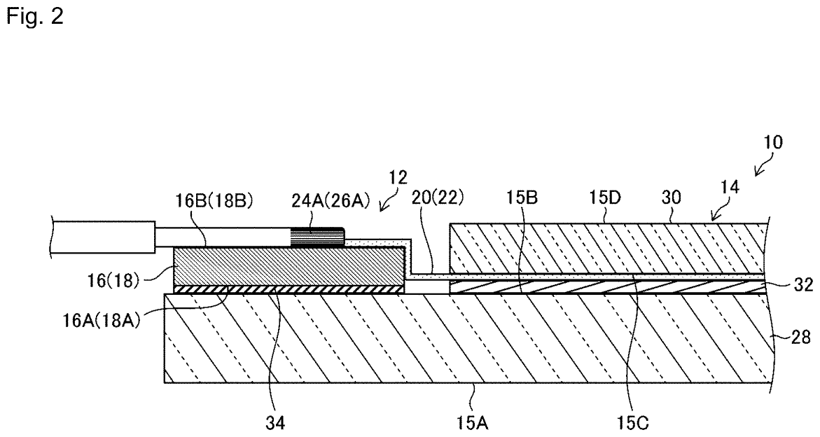

FIG. 1 is a perspective view illustrating an enlarged substantial part of a vehicle window glass 10 according to a first embodiment of the present invention, particularly a perspective view illustrating an enlarged power feeding portion 12 of the vehicle window glass 10 having an entire surface heating function. FIG. 2 is a cross sectional view illustrating the power feeding portion 12 shown in FIG. 1.

As shown in FIGS. 1 and 2, the vehicle window glass 10 comprises a laminated glass 14, plate bodies (hereinafter referred to as relay boards) 16 and 18, bus bars 20 and 22, and lead wires 24 and 26. Further, in FIG. 1, as illustrated by the double-dotted line, the vehicle window glass 10 has a plurality of heating wires 27, one end of the heating wires 27 is electrically connected to the bus bar 20, and the other end is electrically connected to the bus bar 22. According to the vehicle window glass 10 constituted as above, by feeding power to the bus bar on the anode side, for example the bus bar 20, to make the heating wires 27 generate heat thereby to heat the laminated glass 14 in a wide range. The heating wires 27 are an example of the functional member and may, for example, be wavey tungsten wires. The heating wires 27 are provided with the above bus bars 20 and 22. The relay boards 16 and 18, and the bus bars 20 and 22, are one of constituents constituting the power feeding portion 12.

The laminated glass 14 is a laminated glass having an outer glass 28 located on the vehicle exterior side and an inner glass 30 located on the vehicle interior side, and a resin film 32 sandwiched between the outer glass 28 and the inner glass 30. The bus bars 20 and 22 and the heating wires 27 are disposed between the outer glass 28 and the inner glass 30.

Material constituting the outer glass 28 and the inner glass 30 may be inorganic glass or may be organic glass. The inorganic glass may, for example, be soda lime glass, aluminosilicate glass, borosilicate glass, alkali free glass or quartz glass. The outer glass 28 located on the vehicle exterior side is preferably inorganic glass in view of scratch resistance, and is preferably soda lime glass in view of forming property. In a case where the outer glass 28 and the inner glass 30 are soda lime glass, clear glass, green glass containing iron contents in a predetermined amount or more, or UV cut green glass may suitable be used.

Inorganic glass may be either non-tempered glass or tempered glass. Non-tempered glass is one obtained by forming molten glass into a plate, followed by annealing. Tempered glass is one having a compression stress layer formed on the surface of non-tempered glass.

Tempered glass may be either physically tempered glass such as air-tempered glass or chemically tempered glass. In a case of physically tempered glass, the glass surface may be tempered by forming a compression stress layer on the glass surface by a temperature difference between the glass surface and the glass interior e.g. by operation other than annealing, such as quenching a glass plate uniformly heated in bending, from a temperature in the vicinity of the softening point.

In a case of chemically tempered glass, the glass surface may be tempered, for example, after bending, by forming compression stress on the glass surface e.g. by ion exchange method. Otherwise, glass which absorbs ultraviolet rays or infrared rays may be used, and further, the glass is preferably transparent, but a glass plate colored to such an extent not to impair transparency may be used.

As a material of organic glass, a transparent resin such as a polycarbonate, an acrylic resin such as polymethyl methacrylate, polyvinyl chloride or polystyrene may be mentioned.

The outer glass 28 and the inner glass 30 are not particularly limited to rectangular, and they may be formed into various shapes with various curvatures. For bending the outer glass 28 and the inner glass 30, gravity forming, press forming or roller forming may, for example, be employed. The method of forming the outer glass 28 and the inner glass 30 is not particularly limited, and in the case of inorganic glass for example, a glass plate formed by e.g. float process is preferred.

The plate thickness of the outer glass 28 is preferably 1.1 mm or more and 5 mm or less. When the plate thickness of the outer glass 28 is 1.1 mm or more, the outer glass 28 has sufficient strength such as flying stone resistance, and when it is 5.0 mm or less, the mass of the laminated glass 14 will not be too large, such being favorable in view of mileage of the vehicle. The plate thickness of the outer glass 28 is more preferably 1.5 mm or more and 3.5 mm or less, further preferably 1.8 mm or more and 2.6 mm or less.

The plate thickness of the inner glass 30 is preferably 0.3 mm or more and 2.3 mm or less. When the plate thickness of the inner glass 30 is 0.3 mm or more, good handling efficiency will be obtained, and when it is 2.3 mm or less, the mass will not be too large.

When the laminated glass 14 is used, for example, for a head-up display, the outer glass 28 and the inner glass 30 may not have a constant plate thickness and may have a non-uniform plate thickness by location as the case requires. For example, in a case where the laminated glass 14 is a windshield, either one or both of the outer glass 28 and the inner glass 30 may have a wedge cross section such that the plate thickness increases from the lower side toward the upper side of the windshield, in a state where the windshield is attached to a vehicle. In such a case, when the film thickness of the resin film 32 is constant, the total wedge angle of the outer glass 28 and the inner glass 30 may vary within a range of more than 0 mrad and 1.0 mrad or less.

In a case where the outer glass 28 and the inner glass 30 are curved inorganic glass, the outer glass 28 and the inner glass 30 are bent, after formation by float process and before bonding by the resin film 32. Bending is carried out by heating and softening glass. The glass heating temperature at the time of bending is from about 550° C. to about 700° C. In a case where the outer glass 28 and the inner glass 30 are curved inorganic glass, the radii of curvature of the outer glass 28 and the inner glass 30 may be from 1,000 to 100,000 mm. The outer glass 28 and the inner glass 30 may be single curved which are bent only in a vertical direction or in a left-right direction, or may be double curved which are bent both in a vertical direction and in a left-right direction. The radii of curvature of the outer glass 28 and the inner glass 30 may be the same or different.

For the resin film 32, a thermoplastic resin is used in many cases, and for example, a thermoplastic resin which has been used for such a type of application, such as a plasticized polyvinyl acetal resin, a plasticized polyvinyl chloride resin, a saturated polyester resin, a plasticized saturated polyester resin, a polyurethane resin, a plasticized polyurethane resin, an ethylene/vinyl acetate copolymer resin, an ethylene/ethyl acrylate copolymer resin, a cycloolefin polymer resin or an ionomer resin may be mentioned. Further, a resin composition containing a modified block copolymer hydride disclosed in Japanese Patent No. 6065221 may also be suitably used.

Among them, in view of excellent balance of various performances such as transparency, weather resistance, strength, adhesion, penetration resistance, impact energy absorption property, moisture resistance, heat shielding property and sound insulating property, a plasticized polyvinyl acetal resin is suitably used. Such a thermoplastic resin may be used alone or in combination of two or more. “Plasticized” in the plasticized polyvinyl acetal resin means being plasticized by addition of a plasticizer. The same applies to the other plasticized resins.

The polyvinyl acetal resin may be a polyvinyl formal resin obtained by reacting polyvinyl alcohol (PVA) and formaldehyde, a narrowly defined polyvinyl acetal resin obtained by reacting PVA and acetaldehyde, a polyvinyl butyral resin (PVB) obtained by reacting PVA and n-butyraldehyde, or the like. Particularly in view of excellent balance of various performances such as transparency, weather resistance, strength, adhesion, penetration resistance, impact energy absorbing property, moisture resistance, heat shielding property and sound insulating property, PVB is mentioned as a preferred polyvinyl acetal resin. Such a polyvinyl acetal resin may be used alone or in combination of two or more.

However, the material forming the resin film 32 is not limited to a thermoplastic resin. The resin film 32 may contain functional particles of e.g. an infrared absorbing agent, an ultraviolet absorbing agent or a light emitting agent. Further, the resin film 32 may have a colored portion called a shade band. The coloring pigment to be used for forming the colored portion is not particularly limited so long as it can be used for plastic and it achieves a visible light transmittance of the colored portion of 40% or less, and for example, an azo, phthalocyanine, quinacridone, perylene, perinone, dioxazine, anthraquinone or isoindolinone organic coloring pigment or an inorganic coloring pigment such as an oxide, a hydroxide, a sulfide, a chromate, a sulfate, a carbonate, a silicate, a phosphate, an arsenate, a ferrocyanide, carbon or a metal powder may be mentioned. Such a coloring pigment may be used alone or in combination of two or more. The amount of the coloring pigment added may be optional depending upon the desired color and is not particularly limited so long as a visible light transmittance of the colored portion of 40% or less is achieved.

The film thickness of the resin film 32 is preferably 0.5 mm or more. When the film thickness of the resin film 32 at the thinnest portion is 0.5 mm or more, sufficient impact resistance as the laminated glass will be achieved. Further, the film thickness of the resin film 32 is preferably 3 mm or less. When the film thickness of the resin film 32 is 3 mm or less, the mass of the laminated glass 14 may not be too large. The maximum value of the film thickness of the resin film 32 is more preferably 2.8 mm or less, further preferably 2.6 mm or less.

When the laminated glass 14 is used, for example, for a head-up display, the resin film 32 may not have a constant film thickness and may have a non-uniform film thickness by location as the case requires. For example, in a case where the laminated glass 14 is a windshield, the resin film 32 may have a wedge cross section such that the film thickness increases from the lower side toward the upper side of the windshield, in a state where the windshield is attached to a vehicle. In such a case, when the plate thicknesses of the outer glass 28 and the inner glass 30 are constant, the wedge angle of the resin film 32 varies within a range of more than 0 mrad and 1.0 mrad or less.

The resin film 32 may have three or more layers. For example, by the interlayer having three or more layers such that the elastic modulus in shear of any layer excluding both the outermost side layers is made smaller than the elastic moduli in shear of both the outermost side layers e.g. by adjusting the plasticizer, the sound insulating properties of the laminated glass 14 can be improved. In such a case, the elastic moduli in shear of both the outermost side layers may be the same or different.

The total thickness of the laminated glass 14 is preferably 2.8 mm or more and 10 mm or less. When the total thickness of the laminated glass 14 is 2.8 mm or more, sufficient stiffness can be secured. Furter, when the total thickness of the laminated glass 14 is 10 mm or less, a sufficient transmittance will be obtained and the haze can be reduced at the same time.

To produce the laminated glass 14, the resin film 32 is sandwiched between the outer glass 28 and the inner glass 30 to form a laminate. The laminate is put, for example, in a rubber bag or a rubber chamber, or a resin bag, and bonded in vacuum under a pressure of −65 kPa to −100 kPa at a temperature of from about 70° C. to about 110° C.

Further, for example, by contact bonding treatment of heat pressing the laminate at a temperature of from 100° C. to 150° C. under a pressure of from 0.6 MPa to 1.3 MPa, a laminated glass 14 with more excellent durability can be obtained. However, considering simplification of the process and properties of the material to be sealed in the laminated glass 14, in some cases, the heat pressing step may not be employed. That is, a method called “cold bending” may be employed such that the outer glass 28 and the inner glass 30 are bonded in a state where either one or both of the glass plates underwent elastic deformation. Cold bending may be conducted by using a laminate of the outer glass 28, the inner glass 30 and the resin film 32 fixed by a temporary fixing means such as a tape, a known preliminary contact bonding apparatus such as a nip roller, a rubber bag or a rubber chamber, and an autoclave.

As shown in FIG. 1, at a part of the edge portion (hereinafter referred to as lower edge) 14A on the lower side of the laminated glass 14, a notch 14B having the inner glass 30 offset by the outer glass 28 is provided. This notch 14B is formed by linearly forming the lower edge 28A of the outer glass 28 and cutting off a part of the lower edge 30A of the inner glass 30 in an arc shape so as to penetrate in the plate thickness direction. Further, the resin film 32 is also cut off in an arc shape along the outline of the notch 14B. The shape of cutting the lower edge 30A to form the notch 14B is not limited to an arc and may, for example, be a rectangle.

The relay boards 16 and 18 are constituted in a rectangular shape as an example, and in the notch 14B, are bonded to the vehicle interior side surface of the outer glass 28 by a double-sided adhesive tape 34. Further, the relay boards 16 and 18 have a thickness of, for example, 1 mm or more, Thus, heat at the time soldering for bonding the bus bars 20 and 22 by using solder (including lead solder and lead free solder, the same applies hereinafter) 23, can be dispersed by the relay boards 16 and 18. The relay boards 16 and 18 are an example of a plate-like body of the conductive member and may, for example, be a copper plate having silver plating applied. Further, the relay board 16 is an example of the first plate-like body, and the relay board 18 is an example of the second plate-like body. Further, the double-sided adhesive tape 34 is an example of the adhesive member.

Here, as shown in FIG. 2, among the glass surfaces on both sides of the outer glass 28, the glass surface located on the vehicle exterior side will be referred to as a first surface 15A, the glass surface located on the vehicle interior side as a second surface 15B, and among the glass surfaces on both sides of the inner glass 30, the glass surface located on the vehicle exterior side as a third surface 15C, and the glass surface located on the vehicle interior side as a fourth surface 15D. Further, of the relay boards 16 and 18, the surfaces located on the vehicle exterior side will be referred to as first surfaces 16A and 18A, and the surfaces located on the vehicle interior side as second surfaces 16B and 18B. In such a case, the first surfaces 16A and 18A are bonded to the second surface 15B by the double-sided adhesive tape 34.

The bus bars 20 and 22 are disposed between the resin film 32 and the third surface 15C together with the heating wires 27. One ends 20A and 22A of the bus bars 20 and 22 are formed to extend toward the notch 14B and are electrically connected to the second surfaces 16B and 18B of the relay boards 16 and 18 by the above described solder 23. The bus bars 20 and 22 are an example of the power feeding member and may, for example, be a ribbon-shaped copper foil coated with solder. Further, the bus bar 20 is an example of the first power feeding member, and the bus bar 22 is an example of the second power feeding member.

The lead wires 24 and 26 are provided from outside the laminated glass 14, and one ends 24A and 26A are electrically connected to the second surfaces 16B and 18B of the relay boards 16 and 18 by solder 25, whereby the bus bars 20 and 22 are electrically connected to the lead wires 24 and 26 on the relay boards 16 and 18. The other ends of the lead wires 24 and 26 are connected to a power source such as a battery mounted on the vehicle.

According to such a constituted vehicle window glass 10 of the first embodiment, between the outer glass 28 and the inner glass 30, the heating wires provided with the bus bars 20 and 22 are present, in the notch 14B, the relay boards 16 and 18 are disposed, and on the relay boards 16 and 18, the bus bars 20 and 22 and the lead wires 24 and 26 are electrically connected respectively by solders 23 and 25. Thus, heat at the time of soldering with the solders 23 and 25 is dispersed by the relay boards 16 and 18 and is hardly transmitted to the outer glass 28, whereby heat at the time of soldering with the solders 23 and 25 will not be applied locally to the outer glass 28, and damages to the outer glass 28 can be prevented. Thus, according to the first embodiment, the vehicle window glass 10 with high quality having influence by soldering over glass suppressed, even when provided with a functional member which requires power supply, can be provided.

The operation to connect the lead wires 24 and 26 on the relay boards 16 and 18 by soldering may be carried out in a state where the relay boards 16 and 18 are bonded to the outer glass 28, or, the above operation of soldering may be preliminary carried out, and then the relay boards 16 and 18 having the lead wires 24 and 26 connected may be bonded to the outer glass 28, whereby it is possible to prevent the heat of the solder 25 from being transmitted to the double-sided adhesive tape 34 and the outer glass 28 via the relay boards 16 and 18.

An example of the vehicle window glass 10 according to the first embodiment is shown in which the relay boards 16 and 18, are connected to the bus bars 20 and 22 and to the lead wires 24 and 26, by the solders 23 and 25. However, the present invention is not limited to such an embodiment, and they may be electrically connected for example by a conductive adhesive, welding or mechanical contact. A conductive adhesive is a resin material having a conductive filler such as metal particles dispersed in a binder resin such as an epoxy or urethane resin so that the filler forms conductive paths after bonding. The conductive adhesive may, for example, be a conductive paste such as a silver paste or an anisotropic conductive paste, or an anisotropic conductive film. Welding is an operation for electrical connection by fusion welding, brazing or pressure welding, and mechanical contact is an operation for electrical connection e.g. by calking.

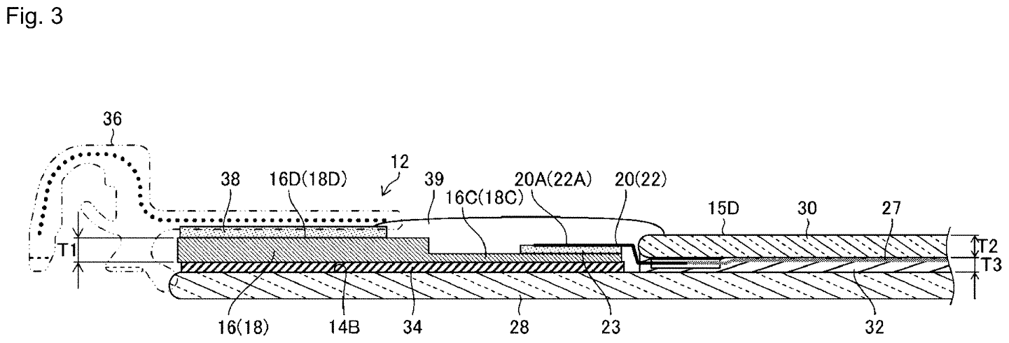

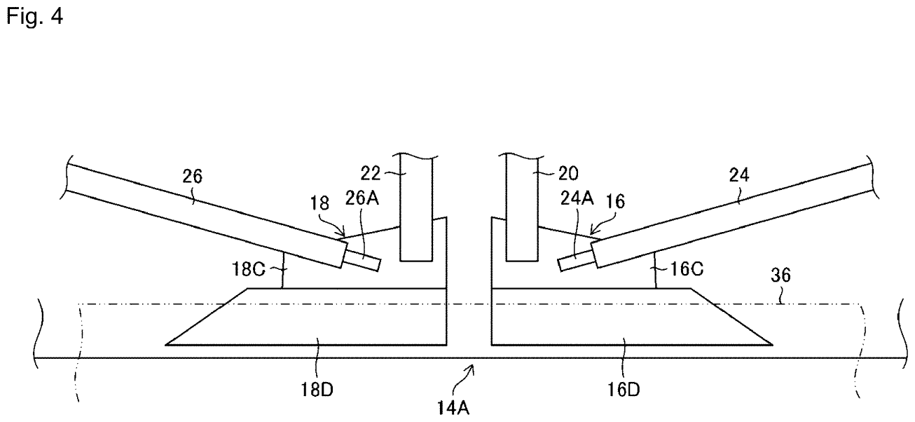

Further, as shown in the cross sectional view illustrating the power feeding portion 12 in FIG. 3, the vehicle window glass 10 may be provided with a sealing member 36 illustrated by the double-dotted line along the lower edge 14A of the laminated glass 14 in some cases. In such a case, it is necessary to wire the lead wires 24 and 26 so that the lead wires 24 and 26 will not interfere with the sealing member 36. In such a case, as shown in the plan view illustrating the power feeding portion 12 in FIG. 4, the lead wires 24 and 26 are disposed in directions apart from the lower edge 14A from the respective one ends 24A and 26A as starting points, whereby the lead wires 24 and 26 can be disposed without interfering with the sealing member 36.

Further, in a case where the sealing member 36 is provided as shown in FIG. 3, in the vicinity of the lower edge 14A of the laminated glass 14 of the relay boards 16 and 18, the thickness T1 of the relay boards 16 and 18 is preferably the same as the sum of the plate thickness T2 of the inner glass 30 and the thickness T3 of the resin film 32.

In such a case, the sealing member 36 is preferably bonded to at least a part of the second surfaces 16B and 18B of the relay boards 16 and 18, in the vicinity of the lower edge 14A of the laminated glass 14 of the relay boards 16 and 18, whereby on the power feeding portion 12, the sealing member 36 can be bonded to the fourth surface 15D of the inner glass 30 on the same plane. In such a case, bonding of the relay boards 16 and 18 and the sealing member 36 is conducted by a double-sided adhesive tape 38 as an example.

Further, as shown in FIG. 3, the power feeding portion 12 is sealed by a sealing agent 39 filled in the notch 14B. In such a case, it is preferred that the thicknesses of connection portions 16C and 18C to which the bus bars 20 and 22 and the lead wires 24 and 26 are connected, on the relay boards 16 and 18, are thinner than the thicknesses of bonding portions 16D and 18D to which the sealing member 36 is bonded, whereby the power feeding portion 12 can securely be sealed by the sealing agent 39. In such a case, the thickness T1 of the relay boards 16 and 18 means the thickness of the bonding portions 16D and 18D.

### Second Embodiment

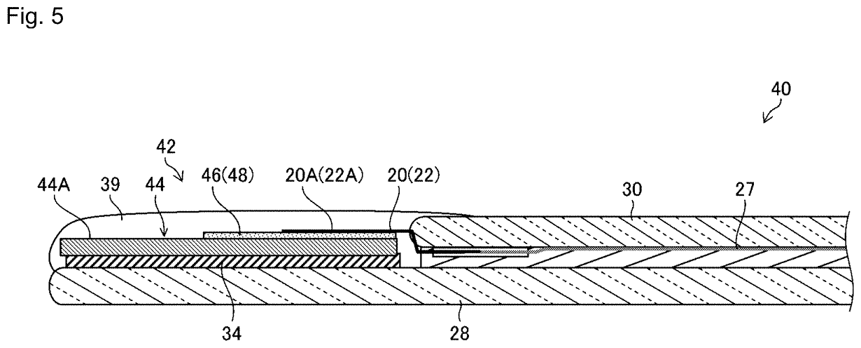

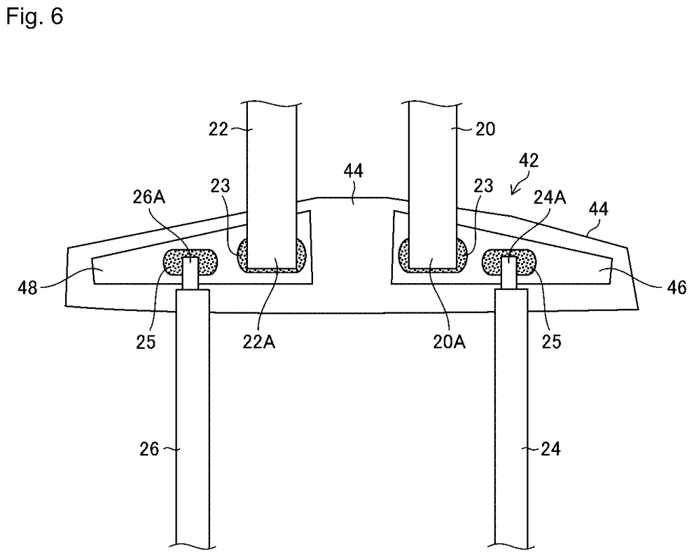

FIG. 5 is a cross sectional view illustrating an enlarged substantial part of the structure of a power feeding portion 42 of a vehicle window glass 40 according to a second embodiment of the present invention. FIG. 6 is a plan view illustrating the power feeding portion 42 shown in FIG. 5. Hereinafter, in description of the vehicle window glass 40, members the same as or similar to those of the vehicle window glass 10 shown in FIGS. 1 to 4 are represented by the same reference symbols, and description of such members is omitted. The vehicle window glass 40 is also provided with heating wires 27 as the functional member.

The vehicle window glass 40 is different in the constitution from the vehicle window glass 10 in that instead of the relay boards 16 and 18 as a conductive member, a substrate 44 as an insulating member is employed. The substrate 44 has a thickness of for example 1 mm or more and is bonded to the outer glass 28 via a double-sided adhesive tape 34. And, other differences are such that electrodes 46 and 48 composed of a conductive material are provided on the vehicle interior side surface 44A of the substrate 44, and the electrodes 46 and 48, and one ends 20A and 22A of the bus bars 20 and 22, are electrically connected by solder 23, and the electrodes 46 and 48, and one ends 24A and 26A of the lead wires 24 and 26, are electrically connected by solder 25.

Here, as the substrate 44, a plate-like body composed of an insulating resin material such as an epoxy resin, or a plate-like body having a laminate of glass fiber cloths impregnated with an epoxy resin, may, for example, be mentioned. Further, as the electrodes 46 and 48, a copper foil may, for example, be mentioned. The copper foil may be formed by applying a copper paste on the surface 44A of the substrate 44 by screen printing. The electrode 46 is an example of the first electrode, and the electrode 48 is an example of the second electrode.

According to such a constituted vehicle window glass 40 by the second embodiment also, heat at the time of soldering with the solders 23 and 25 is dispersed by the substrate 44, and is hardly transmitted to the outer glass 28 due to a low coefficient of thermal conductivity of the substrate 44. Thus, heat at the time of soldering with the solders 23 and 25 will not be applied locally to the outer glass 28, and thus damages to the outer glass 28 can be prevented. Thus, according to the second embodiment, the vehicle window glass 40 with high quality, provided with heating wires 27 as a functional member, can be provided.

An example of the vehicle window glass 40 according to the second embodiment is shown in which the electrodes 46 and 48 are connected to the bus bars 20 and 22 and to the lead wires 24 and 26, by the solders 23 and 25. However, the present invention is not limited to such an embodiment, and in the same manner as the vehicle window glass 10 according to the first embodiment, they may be electrically connected by a conductive adhesive, welding or mechanical contact.

Further, in a case where the vehicle window glass 40 according to the second embodiment is provided with the sealing member 36 shown in FIG. 3, the substrate 44 shown in FIG. 6 is constituted preferably in the same manner as the relay boards 16 and 18 shown in FIG. 3. That is, the substrate 44 is constituted preferably in a stepped shape having connection portions to which the bus bars 20 and 22 and the lead wires 24 and 26 are connected, and bonding portions to which the sealing member 36 is bonded.

### Third Embodiment

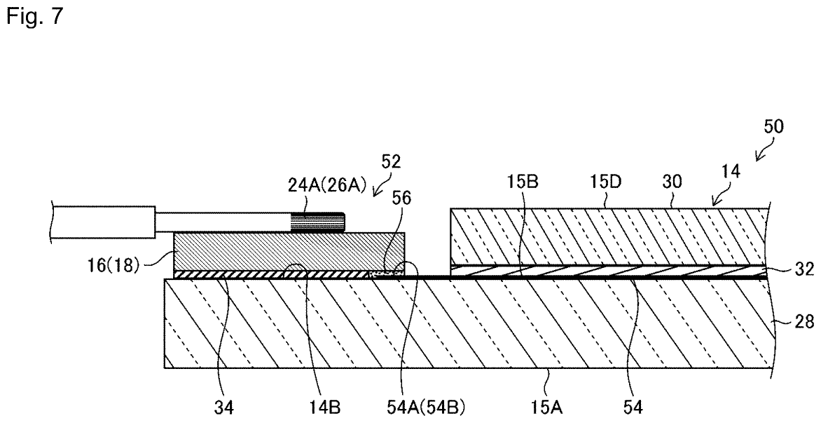

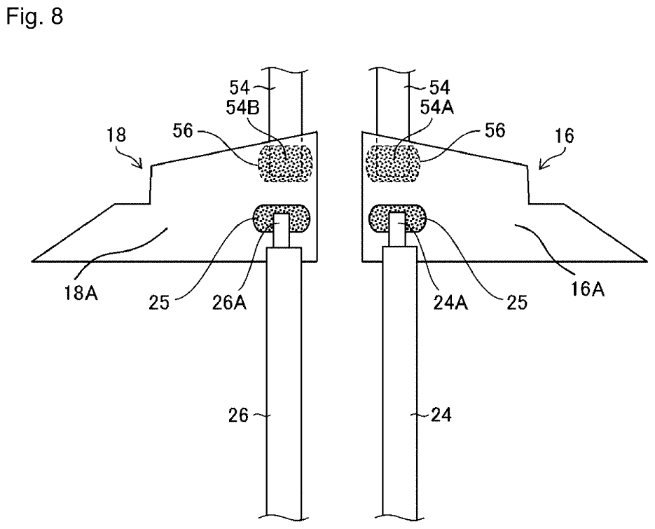

FIG. 7 is a cross sectional view illustrating an enlarged substantial part of the structure of a power feeding portion 52 of a vehicle window glass 50 according to a third embodiment of the present invention. FIG. 8 is a plan view illustrating the power feeding portion 52 shown in FIG. 7. Hereinafter, in description of the vehicle window glass 50, members the same as or similar to those of the vehicle window glass 10 shown in FIGS. 1 to 4 are represented by the same reference symbols, and description of such members is omitted.

On comparison between the vehicle window glass 10 and the vehicle window glass 50, the vehicle window glass 50 is different from the vehicle window glass 10 having an entire surface heating function, in that it has a wiper deicing function. The specific difference in the constitution is that the vehicle window glass 50 is provide with a functional member having conductive wires 54, a first terminal portion 54A electrically connected to one end of the conductive wires 54, and a second terminal portion 54B electrically connected to the other end, instead of the functional member provided with the heating wires 27 and the bas bars 20 and 22. The conductive wires 54 are formed on the second surface 15B of the outer glass 28. And, other differences are such that the first terminal portion 54A and the second terminal portion 54B are provided in the notch 14B, the first terminal portion 54A is electrically connected to the first surface 16A of the relay board 16 by a conductive adhesive 56, and the second terminal portion 54B is electrically connected to the first surface 18A of the relay board 18 by a conductive adhesive 56.

According to such a constituted vehicle window glass 50 of the third embodiment also, heat at the time of soldering to connect the lead wires 24 and 26 to the relay boards 16 and 18 with the solder 25 are dispersed by the relay boards 16 and 18 and is hardly transmitted to the outer glass 28, whereby heat at the time of soldering with the solder 25 will not be applied locally to the outer glass 28, and damages to the outer glass 28 can be prevented. Thus, according to the third embodiment, the vehicle window glass 50 with high quality, provided with the conductive wires 54 as a functional member, can be provided.

An example of the vehicle window glass 50 according to the third embodiment is shown in which the first terminal portion 54A and the first surface 16A, and the second terminal portion 54B and the first surface 18A, are respectively connected by the conductive adhesive 56. However, the present invention is not limited to such an embodiment, and they may be electrically connected by welding or mechanical contact.

### Fourth Embodiment

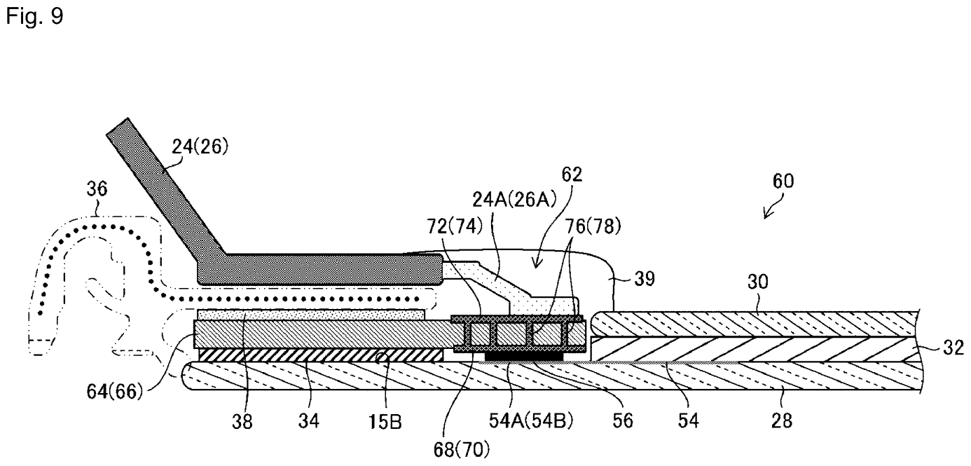

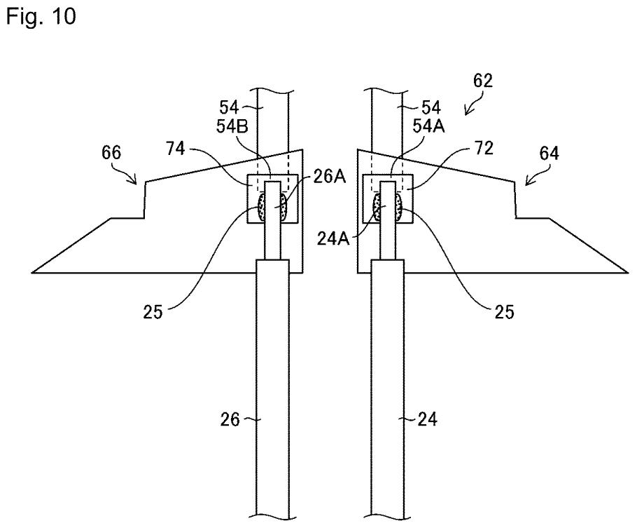

FIG. 9 is a cross sectional view illustrating an enlarged substantial part of the structure of a power feeding portion 62 of a vehicle window glass 60 according to a fourth embodiment of the present invention. FIG. 10 is a plan view illustrating the power feeding portion 62 shown in FIG. 9. Hereinafter, in description of the vehicle window glass 60, members the same as or similar to those of the vehicle window glass 50 shown in FIGS. 7 and 8 are represented by the same reference symbols, and description of such members is omitted. The vehicle window glass 60 is also provided with conductive wires 54 as the functional member.

The vehicle window glass 60 is different in the constitution from the vehicle window glass 50 in that instead of the relay boards 16 and 18 as a conductive member, substrates 64 and 66 as an insulating member are employed. The substrates 64 and 66 have a thickness of for example 1 mm or more and have the vehicle exterior side surface bonded to the second surface 15B of the outer glass 28 via the double-sided adhesive tape 34. And, other differences are such that on a surface where no double-sided adhesive tape 34 is present on the vehicle exterior side surface of the substrate 64, a first electrode 68 composed of a conductive material is provided, a first terminal portion 54A is electrically connected to the first electrode 68 by a conductive adhesive 56, on a surface where no double-sided adhesive tape 34 is present on the vehicle exterior side surface of the substrate 66, a second electrode 70 composed of the conductive material is provided, and a second terminal portion 54B is electrically connected to the second electrode 70 by a conductive adhesive 56. The substrate 64 is an example of the first plate-like body, and the substrate 66 is an example of the second plate-like body.

Further, on the vehicle interior side surface of the substrate 64, an electrode 72 composed of a conductive material is provided, and the electrode 72 is electrically connected to the first electrode 68 via a conductor 76 disposed to penetrate the substrate 64. And, to the electrode 72, one end 24A of the lead wire 24 is electrically connected by solder 25.

Further, likewise, on the vehicle interior side surface of the substrate 66, an electrode 74 composed of a conductive material is provided, and the electrode 74 is electrically connected to the second electrode 70 via a conductor 78 disposed to penetrate the substrate 66. And, to the electrode 74, one end 26A of the lead wire 26 is electrically connected by solder 25.

According to such a constituted vehicle window glass 60 of the fourth embodiment also, heat at the time of soldering to connect the lead wires 24 and 26 to the electrodes 72 and 74 with the solder 25 is dispersed by the substrates 64 and 66 and is hardly transmitted to the outer glass 28. Thus, heat at the time of soldering with the solder 25 will not be applied locally to the outer glass 28, and thus damages to the outer glass 28 can be prevented. Thus, according to the fourth embodiment, the vehicle window glass 60 with high quality, provided with the conductive wires 54 as a functional member, can be provided.

An example of the vehicle window glass 60 according to the fourth embodiment is shown in which the first terminal portion 54A and the first electrode 68, and the second terminal portion 54B and the second electrode 70, are respectively connected by the conductive adhesive 56. However, the present invention is not limited to such an embodiment, and they may be electrically connected by welding or mechanical contact.

In the above first to fourth embodiments, as the functional member, heating wires 27 and conductive wires 54 are mentioned as examples, however, the present invention is not limited to such specific description, and the functional member is not limited and may, for example, be a light control member or a display, so long as it is a functional member disposed between the outer glass 28 and the inner glass 30.

The present invention has been descried above, however, the present invention is not limited to the above embodiments, and various modifications and changes are possible without departing from the intention and the scope of the present invention.

### REFERENCE SYMBOLS

10: Vehicle window glass, 12: power feeding portion, 14: laminated glass, 14B:

notch, 16: relay board, 18: relay board, 20: bus bar, 22: bus bar, 23: solder, 24: lead wire, 25: solder, 26: lead wire, 27: heating wires, 28: outer glass, 30: inner glass, 32: resin film, 34: double-sided adhesive tape, 36: sealing member, 38: double-sided adhesive tape, 39: sealing agent, 40: vehicle window glass, 42: power feeding portion, 44: substrate, 46: electrode, 48: electrode, 50: vehicle window glass, 52: power feeding portion, 54: conductive wire, 54A: first terminal portion, 54B: second terminal portion, 56: conductive adhesive, 60: vehicle window glass, 62: power feeding portion, 64: substrate, 66: substrate, 68: first electrode, 70: second electrode, 72: electrode, 74: electrode, 76: conductor, 78: conductor

What is claimed is:

1. A vehicle window glass provided with a laminated glass comprising a vehicle exterior side glass and a vehicle interior side glass, and an interlayer sandwiched between the vehicle exterior side glass and the vehicle interior side glass,
wherein the vehicle interior side glass has a notch formed to penetrate in the plate thickness direction of the vehicle interior side glass at the edge portion on the lower side,
between the vehicle exterior side glass and the vehicle interior side glass, a functional member provided with a power feeding member is present,
a plate-like body is disposed in the notch, and
on the plate-like body, the power feeding member and a lead wire provided from outside the laminated glass are electrically connected.

2. The vehicle window glass according to claim 1, wherein in the notch, the vehicle exterior side surface of the plate-like body and the vehicle interior side surface of the vehicle exterior side glass are bonded by an adhesive member.

3. The vehicle window glass according to claim 2, wherein the plate-like body is a conductive member, and
on the vehicle interior side surface of the plate-like body, the plate-like body and the power feeding member are electrically connected.

4. The vehicle window glass according to claim 3, wherein the power feeding member and the lead wire are electrically connected by the plate-like body and the lead wire being electrically connected on the vehicle interior side surface of the plate-like body.

5. The vehicle window glass according to claim 4, wherein the plate-like body and the power feeding member are electrically connected by lead solder, lead free solder, a conductive adhesive, welding or mechanical contact, and the plate-like body and the lead wire are electrically connected by lead solder, lead free solder, a conductive adhesive, welding or mechanical contact.

6. The vehicle window glass according to claim 2, wherein the plate-like body is an insulating member,
on the vehicle interior side surface of the plate-like body, an electrode composed of a conductive material is provided, and
the electrode and the power feeding member are electrically connected.

7. The vehicle window glass according to claim 6, wherein the power feeding member and the lead wire are electrically connected by the electrode and the lead wire being electrically connected.

8. The vehicle window glass according to claim 7, wherein the electrode and the power feeding member are electrically connected by lead solder, lead free solder, a conductive adhesive, welding or mechanical contact, and
the electrode and the lead wire are electrically connected by lead solder, lead free solder, a conductive adhesive, welding or mechanical contact.

9. The vehicle window glass according to claim 3, wherein the functional member comprises a plurality of heating wires,
one end of the plurality of heating wires is electrically connected to a first power feeding member and the other end is electrically connected to a second power feeding member,
the plurality of heating wires, the first power feeding member and the second power feeding member are disposed between the interlayer and the vehicle interior side glass,
the plate-like body comprises a first plate-like body and a second plate-like body, and
the first power feeding member is electrically connected to the first plate-like body and the second power feeding member is electrically connected to the second plate-like body.

10. The vehicle window glass according to claim 6, wherein the functional member comprises a plurality of heating wires,
one end of the plurality of heating wires is electrically connected to a first power feeding member and the other end is electrically connected to a second power feeding member,
the plurality of heating wires, the first power feeding member and the second power feeding member are disposed between the interlayer and the vehicle interior side glass,
the plate-like body comprises a first electrode and a second electrode, and
the first power feeding member is electrically connected to the first electrode and the second power feeding member is electrically connected to the second electrode.

11. The vehicle window glass according to claim 1, wherein the functional member comprises a conductive wire formed on the vehicle interior side surface of the vehicle exterior side glass, a first terminal portion electrically connected to one end of the conductive wire, and a second terminal portion electrically connected to the other end,
the first terminal portion and the second terminal portion are provided in the notch,
the plate-like body comprises a first plate-like body composed of a conductive member and a second plate-like body composed of a conductive member, and
the first terminal portion is electrically connected to the vehicle exterior side surface of the first plate-like body and the second terminal portion is electrically connected to the vehicle exterior side surface of the second plate-like body.

12. The vehicle window glass according to claim 11, wherein the first terminal portion is electrically connected to the vehicle exterior side surface of the first plate-like body by a conductive adhesive, welding or mechanical contact, and
the second terminal portion is electrically connected to the vehicle exterior side surface of the second plate-like body by a conductive adhesive, welding or mechanical contact.

13. The vehicle window glass according to claim 1, wherein the functional member comprises a conductive wire formed on the vehicle interior side surface of the vehicle exterior side glass, a first terminal portion electrically connected to one end of the conductive wire, and a second terminal portion electrically connected to the other end,
the first terminal portion and the second terminal portion are provided in the notch,
the plate-like body comprises a first plate-like body composed of an insulating member and a second plate-like body composed of an insulating member,
on the vehicle exterior side surface of the first plate-like body, a first electrode composed of a conductive material is provided, and on the vehicle exterior side surface of the second plate-like body, a second electrode composed of a conductive material is provided, and
the first terminal portion is electrically connected to the first electrode and the second terminal portion is electrically connected to the second electrode.

14. The vehicle window glass according to claim 13, wherein the first terminal portion is electrically connected to the first electrode by a conductive adhesive, welding or mechanical contact, and
the second terminal portion is electrically connected to the second electrode by a conductive adhesive, welding or mechanical contact.

15. The vehicle window glass according to claim 1, which has a sealing member at a lower side peripheral portion of the laminated glass,
in the vicinity of the laminated glass lower edge portion of the plate-like body, the thickness of the plate-like body is the same as the sum of the plate thickness of the vehicle interior side glass and the thickness of the interlayer, and
in the vicinity of the laminated glass lower edge portion of the plate-like body, at least a part of the vehicle interior side surface of the plate-like body and the sealing member are bonded.
